(19) United States
(12) Patent Application Publication
(10) Pub. No.: US 2018/0253288 A1
(43) Pub. Date: Sep. 6, 2018

(54) DYNAMICALLY PREDICT AND ENHANCE ENERGY EFFICIENCY

(71) Applicant: INTEL IP CORPORATION, Santa Clara, CA (US)

(72) Inventors: Karthik RAMAN, Hillsboro, OR (US); William BROWN, Beaverton, OR (US); Rama Kishan MALLADI, Bangalore (IN); Andrey SEMIN, Feldkirchen / Munich (DE)

(73) Assignee: INTEL IP CORPORATION, Santa Clara, CA (US)

(21) Appl. No.: 15/449,696

(22) Filed: Mar. 3, 2017

(51) Int. Cl. G06F 9/45; G06F 11/30; G06F 11/34; G06F 1/32

(52) U.S. Cl. CPC G06F 8/4432; G06F 11/302; G06F 1/3206; G06F 11/3433; G06F 11/3442; G06F 11/3062

(57) ABSTRACT

The present disclosure provides systems and methods for dynamically predicting and enhancing energy efficiency. Dynamically predicting and enhancing energy efficiency can include determining that the code path for the code executed at run time comprises a branch, selecting a path, corresponding to one of the plurality of versions of the code, from the branch based on the plurality of predictors, the plurality of metrics, and the plurality of versions of the code, and providing the code associated with the path to a processing unit for execution.

### TECHNICAL FIELD

The present disclosure relates to dynamically predicting and enhancing energy efficiency. In particular, the present disclosure relates to dynamically predicting and enhancing energy efficiency of applications in processors.

### BRIEF DESCRIPTION OF THE DRAWINGS

FIG. 1A is a block diagram illustrating a plurality of components of a system for dynamically predicting and enhancing energy efficiency according to various embodiments.

FIG. 1B is a block diagram illustrating an energy efficiency predictor unit of a system for dynamically predicting and enhancing energy efficiency according to various embodiments.

FIGS. 2, 3, and 4 are flow diagrams illustrating methods for dynamically predicting and enhancing energy efficiency according to various embodiments.

FIG. 5 is a block diagram illustrating an example computing device suitable for use to practice aspects of the present disclosure, according to various embodiments.

FIG. 6 is a block diagram illustrating a storage medium having instructions for practicing methods described with reference to FIGS. 1-4, according to various embodiments.

### DETAILED DESCRIPTION OF PREFERRED EMBODIMENTS

Energy efficiency is a metric in modern high performance computing (HPC) systems. Central processing unit (CPU) architectures provide certain new features that improve application performance but also increase power consumption. Use of the CPU for energy efficient performance is intimately related to the software implementation and code generation from the compiler. Often, it can be difficult to predict, at compile time, the best choice for energy efficient performance. For portability reasons, it can be desirable for the same binary to run efficiently on a wide range of current and future CPU architectures.

Examples of the tradeoffs in running software for energy efficient performance include, but are not limited to, using scalar processing at high clock frequencies and/or vector processing that can be throttled to a decreased clock frequency to maintain thermal design power (TDP) limits. Other examples can include whether to use busy waiting versus allowing threads to sleep, whether to use thread and/or worker counts for parallel decompositions, and/or whether to use simultaneous multithreading (SMT) versus single hardware (HW) thread execution.

Mechanisms like CPU frequency throttling to avoid excess power usage (e.g., exceeding TDP limits) can have a negative performance effect. Providing a perfect balance of power and performance (e.g., improved energy efficiency) under TDP limitations can be a great challenge. Unfortunately, frequency throttling can have a deleterious impact on overall application performance in some cases. For example, due to low vectorization speedups and/or slower execution of scalar code, a same throttled frequency can have a deleterious impact on overall application performance in some cases.

A scale of frequency throttling can depend on available power and temperature headrooms. A scale of frequency throttling may vary from part to part (e.g., semiconductor devices) following Silicon manufacturing variability and distribution of temperatures between nodes in different parts of a rack and/or datacenter.

The use of static predictors for energy efficiency may be difficult due to the difficulty in generating accurate cost models for use at compile time and the unknown impact of the characteristics of different workloads that might be used as inputs to an application (e.g., software).

In some embodiments, a solution to dynamically predict the energy efficiency is provided. In some examples, a code path can be selected based on the dynamic prediction of the energy efficiency of the different code paths. As used herein, code can include machine code, assembly code, and/or a higher level language code such as C++ or Java, among other types of code. A code path can include a specific sequence of the code. Code, a code path, and/or a block of code can include loop (e.g., for loops and/or while loops, among other types of loops) library calls, functions, objects, methods, and threads. In some examples, code, a code path, and/or a block of code can include instructions that are executed in a single processor and/or multiple processors simultaneously and/or concurrently.

An energy efficiency predictor unit is described herein. The energy efficiency predictor unit can dynamically monitor various relevant metrics that are mapped to instruction pointers relevant to multiversioned code. The multiversioned code can be generated by the compiler. The multiversioned code can comprise multiple versions of code (e.g., different versions of a same code) and/or of a block of code (e.g., different versions of a same block of code). The multiple versions of code can include a scalar version of code, a vector version of code, and/or serial/parallel versions of code, among other types of code versions. In some examples, different versions of code can comprise successive versions of the development of a code.

In some examples, metrics can include power metrics and performance metrics. Example metrics can also include power consumption metrics, temperature metrics, current metrics, execution of packed vector instruction metrics, instructions per cycle metrics, memory bandwidth usage metrics, and/or wait and sleep instruction metrics, among other metrics. The energy efficiency predictor unit can track the history of prediction decisions (e.g., controlled by logic particular to the architecture) to choose the multiversioned code path predicted to result in the best energy efficient performance. That is, the energy predictor unit can store a selection of a code path and/or predictions in electronic memory. Previous selections and/or predictions can be stored as history. The energy predictor unit can utilize the history to make future decisions based on the history for a certain block of the code. Runtime data from execution of different versions of the code can be stored as history in the electronic memory to improve the accuracy of the predictions.

The energy efficiency predictor unit can take both power and performance, as determined by metrics such as instructions per cycle (IPC), possibly weighted by code version, into consideration under TDP limits. The energy efficiency predictor unit can determine and/or predict a path favorable to power and/or performance metrics.

The following example can describe an implementation of the energy efficiency predictor unit. A “scalar” performance of a loop, or a basic block, can be “X,” and the vectorized version of the loop can perform 30% better than scalar code (1.3X). A power consumption of the scalar loop (e.g., basic block) can be “Y,” and the vector loop can consume 30% more power than the scalar loop due to a heavy usage of advance vector extension (AVX2) code and/or AVX512 code (1.3Y). If the vectorized loop exceeds the TDP thresholds, due to which the core frequency was throttled by 20%, then the vector performance can be reduced to 10% of the scalar code (e.g., 1.1X). But with the core frequency throttling, the power can only be reduced by 10% (1.2Y).

Energy efficiency can describe performance per energy consumption. The energy efficiency of the scalar loop (e.g., basic block) can be “Es=X/Y” while the energy efficiency of the vectorized code can be “Ev=1.1X/1.2Y”; thus “Ev˜=0.9Es.” That is, the energy efficiency of the vectorized code can be lower than scalar code by ˜10% even though the absolute performance of the vectorized code is a bit higher than the absolute performance of the scalar loop. In this example, the energy efficiency of a version of code is provided using a performance metric and a power metric. In some embodiments, a choice of thread count for loops supporting variable thread counts can be defined by a developer as a metric for energy efficiency.

In the following detailed description, reference is made to the accompanying drawings, which form a part hereof, wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternative embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed to imply that these operations are necessarily order dependent. In particular, these operations may not be performed in the order of presentation. Operations described may be performed in an order different from that of the described embodiment. Various additional operations may be performed and/or described. Operations may be omitted in additional embodiments.

For the purposes of the present disclosure, the phrase “A and/or B” means A, B, or A and B. For the purposes of the present disclosure, the phrase “A, B, and/or C” means A, B, C, A and B, A and C, B and C, or A and B and C.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

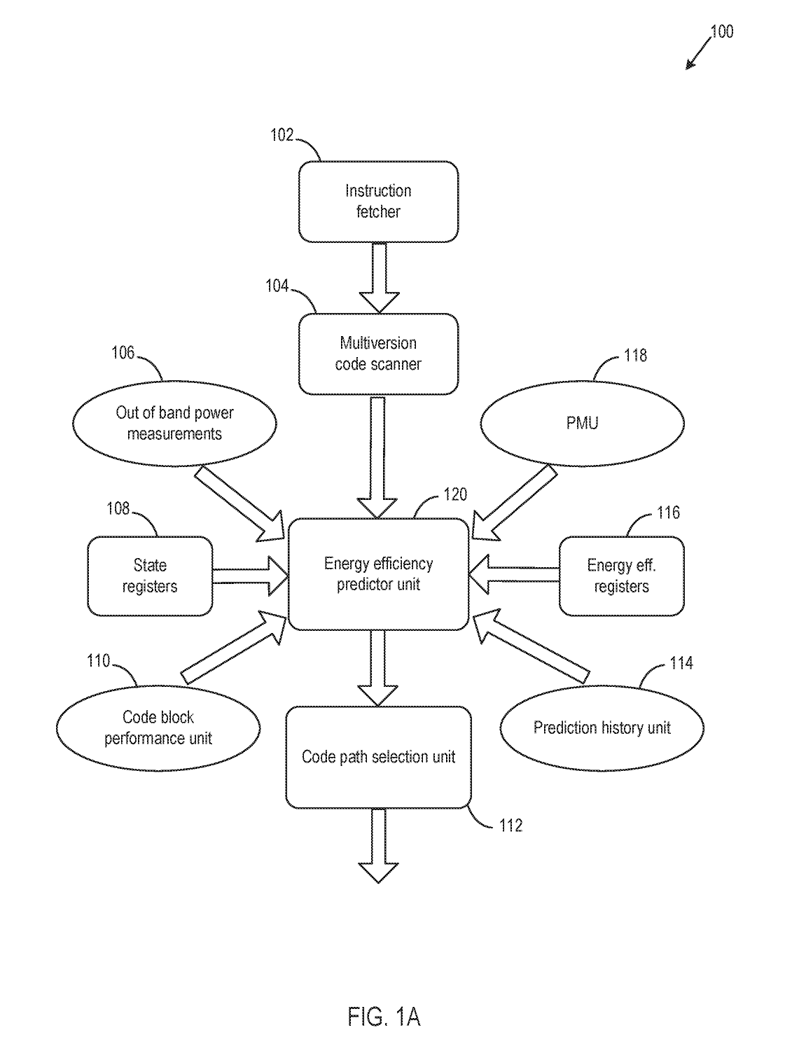

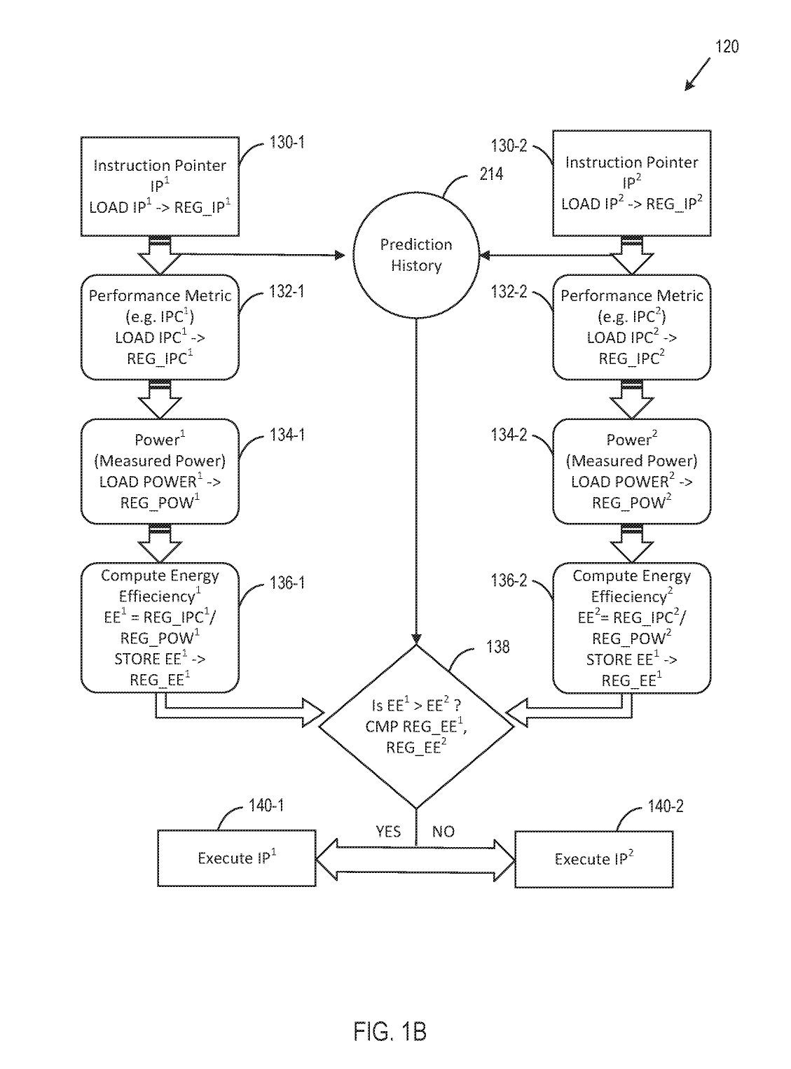

FIG. 1A is a block diagram illustrating a plurality of components of a system 100 for dynamically predicting and enhancing energy efficiency according to various embodiments. FIG. 1A includes an instruction fetcher 102, a multiversion code scanner 104, an out of band power measurement unit 106, state registers 108, a code block performance unit 110, a code path selection unit 112, a prediction history unit 114, energy efficiency registers 116, a performance monitoring unit (PMU) 118 (e.g., IPC via perfmon), and an energy efficiency predictor unit 120.

The different components of the system 100 can include hardware and/or software. That is, the instruction fetcher 102, the multiversion code scanner 104, the out of band power measurement unit 106, the state registers 108, the code block performance unit 110, the code path selection unit 112, the prediction history unit 114, the energy efficiency registers 116, the PMU 118 (e.g., IPC via perfmon), and/or the energy efficiency predictor unit 120 can be implemented purely in hardware, purely in software, and/or in a combination of hardware and software.

The energy efficiency predictor unit 120 can comprise specialized logic in hardware for making decisions based on electronic memory and metrics. The logic can be provided to other functional units in the processors. For example, the energy efficiency predictor unit 120 can comprise memory and a finite state machine which can be used to perform computations in conjunction with and/or independent of a CPU associated with a computing device on which the system 100 is executing.

In some embodiments, the system 100 can be initiated by a processing unit (e.g., CPU). For example, the processing unit may determine that a branch of code exists wherein each of the branches of code corresponds to a version of code. To determine which branch of code to execute, the processing unit can request from the system 100 a code path. The system 100 can select a code path based on the energy efficiency of the code path. To determine the energy efficiency of the code path, the system 100 may utilize multiple components.

The multiversion code scanner 104, in conjunction with the instruction fetcher 102, can comprise one or more compilers to generate multiple versions for a same code in certain cases for optimization purposes. The multiversion code scanner 104 can also select a version of the code to provide to the energy efficiency predictor unit 120 during run time. For example, the instruction fetcher 102 can access code and can provide the code to the multiversion code scanner 104. The multiversion code scanner 104 can generate multiple versions of the code. The multiple versions of the code can be created at compile time and/or run time. In some examples, the multiple versions of the code can be created at a time between compile time and run time.

In some embodiments, multiple versions of code can be generated by a compiler at compile time. The cost model and benefits of the cost model for one version of the code as compared to a different version of the code may not be available at compile time. That is, simply generating multiple versions of code does not provide the ability to determine an energy efficiency associated with executing one version of the code as compared to a different version of the code. As such, only generating multiple versions of the code does not provide the ability to select one version of the code as compared to a different version of the code based on the energy efficiency of the one version of the code.

In some embodiments, multiple versions of a block of code can be generated and/or multiple versions of a code can be generated, wherein code can comprise multiple blocks of code and/or a portion of code that is a standalone piece of code. In some examples, code can describe an application, a portion of an application, and/or a group of applications. Code can include assembly code, executable code, object oriented code, and/or some combination of the same.

For example, source annotations found in the code can be used to determine whether to generate multiple versions of the code and/or the block of code. Source annotations can include comments such as “#pragma multiversion.” The comments can be provided by a developer and can be used to generate the multiple versions of the code. As will be seen below, the multiple versions of the code may be used in conjunction with runtime information to generate a plurality of predictors of the energy efficiency of the multiple versions of the code.

The state registers 108 can be used to store relevant metrics. An energy efficiency metric can be formulated by accounting for performance metrics, power consumption metrics, VPU metrics, and/or IPC metrics, among others.

Performance metrics can be generated and/or provided by the code block performance unit 110 and in conjunction with the PMU 118. The code block performance unit 110 can then store the performance metrics in the state registers 108. The performance metrics can be determined and/or generated by dynamic execution of the code (e.g., code block).

The power consumption metrics can be generated by the out of band power measurement unit 106. The power consumption metrics can be out of band because the measurements of the power consumption do not impact performance of the code (e.g., application). The power consumption metrics can measure the power consumption of code at run time. The power consumption metrics can be generated by dynamic execution of the code.

The VPU metrics describe a VPU utilization. The VPU metrics can be generated and/or provided by the PMU 118. The PMU 118 can store the VPU metrics in the state registers 108. The PMU 118 can also generate IPC metrics and store the IPC metrics in the state registers 108.

The energy efficiency predictor unit 120 can access the metrics through the state registers 108. The energy efficiency predictor unit 120 can include internal registers to store predictions that can be accessed at run time. The energy efficiency predictor unit 120 can also store the predictions in the energy efficiency registers 116. The energy efficiency predictor unit 120 can include logic for architecture-dependent formulation of predictions using the state registers 108, the associated instruction pointers, and the prediction history.

The prediction history unit 114 can manage a history of the predictions generated by the energy efficiency predictor unit 120. The prediction history unit 114 can store the predictions in the energy efficiency registers 116. The prediction history unit 114 can manage an energy efficiency prediction and the actual energy efficiency of a selected code path. The prediction history unit 114 can be used to better predict the energy efficiency of a code path.

The code path selection unit 112 can compare a plurality of predictions generated by the energy efficiency predictor unit 120 and can select one of the plurality of predictions. The code path selection unit 112 can provide a code path corresponding to the selected prediction. In some embodiments, the code path selection unit 112 can provide the code path to a processing unit for execution.

FIG. 1B is a block diagram illustrating an energy efficiency predictor unit 120 of a system for dynamically predicting and enhancing energy efficiency according to various embodiments. In some examples, the energy efficiency predictor unit 120 can include a prediction history 114. That is, the prediction history 114 can be stored in the energy efficiency predictor unit 120.

The energy efficiency predictor unit 120 can load an instruction pointer 130-1 (e.g., ip1) and an instruction pointer 130-2 (e.g., ip2), referred to generally as instruction pointers 130. The instruction pointers 130 can be stored in the state registers 108 shown in FIG. 1A. The instruction pointers 130 can include a reference to versions of a same code. For example, the instruction pointer 130-1 can reference a first code and the instruction pointer 130-2 can reference a second code, where the first code and the second code are different versions of the same code.

The instruction pointer 130-1 can be loaded (e.g., load ip1→reg_ip1) and stored in a variable reg_ip1. The instruction pointer 130-2 can be loaded (load ip2→reg_up2) and stored in a variable reg_ip2. The instruction pointers 130 can be stored in the prediction history 214.

The energy efficiency predictor unit 120 can also load a performance metric 132-1 (e.g., load ipc1→reg_ipc1) of the first code. The energy efficiency predictor unit 120 can load a performance metric 132-2 (e.g., load ipc2→reg_ipc2) of the second code. The energy efficiency predictor unit 120 can also load a measured power 134-1 (e.g., load power 1→reg_pow1) of the first code. The energy efficiency predictor unit 120 can load a measured power 134-2 (e.g., load power 1→reg_pow1) for the second code.

The energy efficiency predictor unit 120 can further compute an energy efficiency 136-1 (e.g., EE1) of the first code and an energy efficiency 136-2 of the second code (e.g., EE2). An example of computing an energy efficiency 136-1 for the first code can include dividing the performance metric 132-1 by the measured power 134-1 (e.g., EE1=reg_ipc1/reg_pow1). An example of computing an energy efficiency 136-2 for the second code can include dividing the performance metric 132-2 by the measured power 134-2 (e.g., EE2=reg_ipc2/reg_pow2). The energy efficiency 136-1 and the energy efficiency 136-2 can be stored in the energy efficiency registers 116 in FIG. 1A.

The energy efficiency predictor unit 120 can compare 138 (e.g., cmp reg_EE1, reg_EE2) the energy efficiency 136-1 and the energy efficiency 136-2. In some examples, data can be retrieved from and/or stored to the prediction history 214 to compare 138 and/or to save the results of the comparison 138. If the energy efficiency 136-1 is greater than the energy efficiency 136-2, then the pointer 130-1 can be selected and used to execute 140-1 the first code. If the energy efficiency 136-2 is greater than or equal to the energy efficiency 136-1, then the pointer 130-2 can be selected and used to execute 140-2 the second code. For example, the energy efficiency predictor unit 120 can provide a selected pointer to the code path selection unit 112 in FIG. 1.

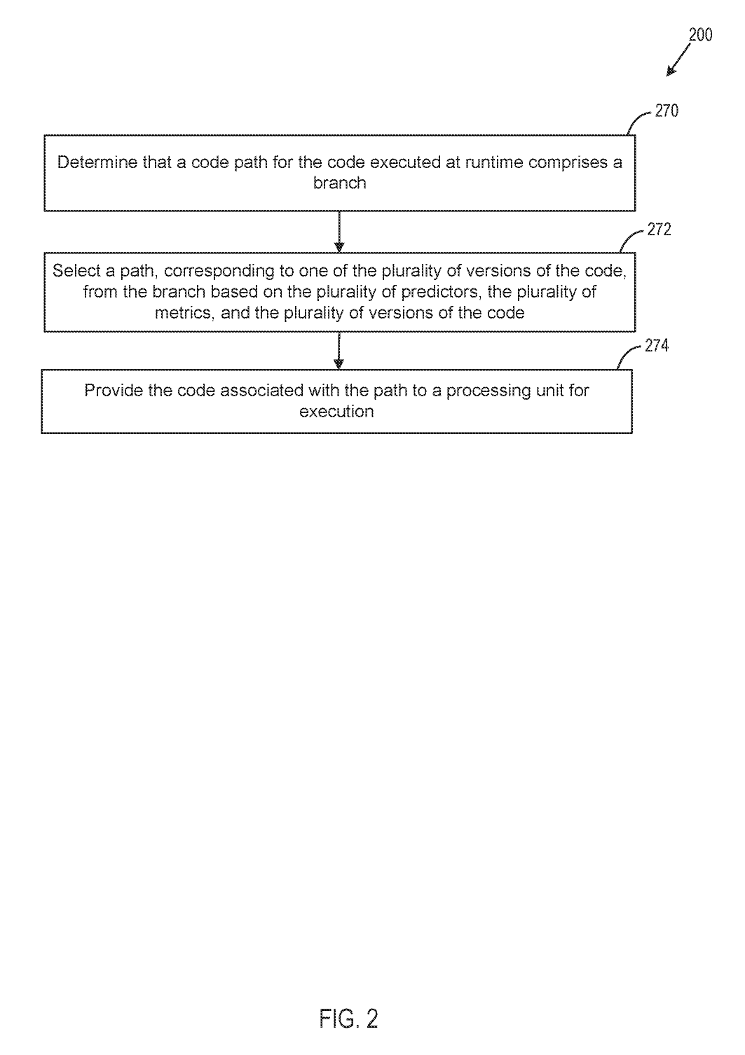

FIG. 2 is a flow diagram illustrating a method 200 for dynamically predicting and enhancing energy efficiency according to various embodiments. The method 200 comprises determining 270 that a code path for the code executed at run time comprises a branch; selecting 272 a path, corresponding to one of the plurality of versions of the code, from the branch based on the plurality of predictors, the plurality of metrics, and the plurality of versions of the code; and providing 274 the code associated with the path to a processing unit for execution.

The method 200 can also include generating the plurality of predictors based on the plurality of metrics. The plurality of predictors can be generated by an energy efficient predictor unit. Each of the plurality of predictors can include a ratio of one or more performance metrics to one or more energy efficiency metrics. The lower predictors can be selected over higher predictors.

The method 200 can also include generating the plurality of versions of the code at compile time. The method 200 can also include generating the plurality of versions of the code at compile time as defined by a compiler. The plurality of versions of the code can comprise the plurality of versions of a block of the code. The block of the code can comprise a loop of code that is part of the code. The plurality of versions of the code can comprise different versions for a same code.

The method 200 can also include generating the metrics at run time. The method 200 can also include generating the metrics at compile time.

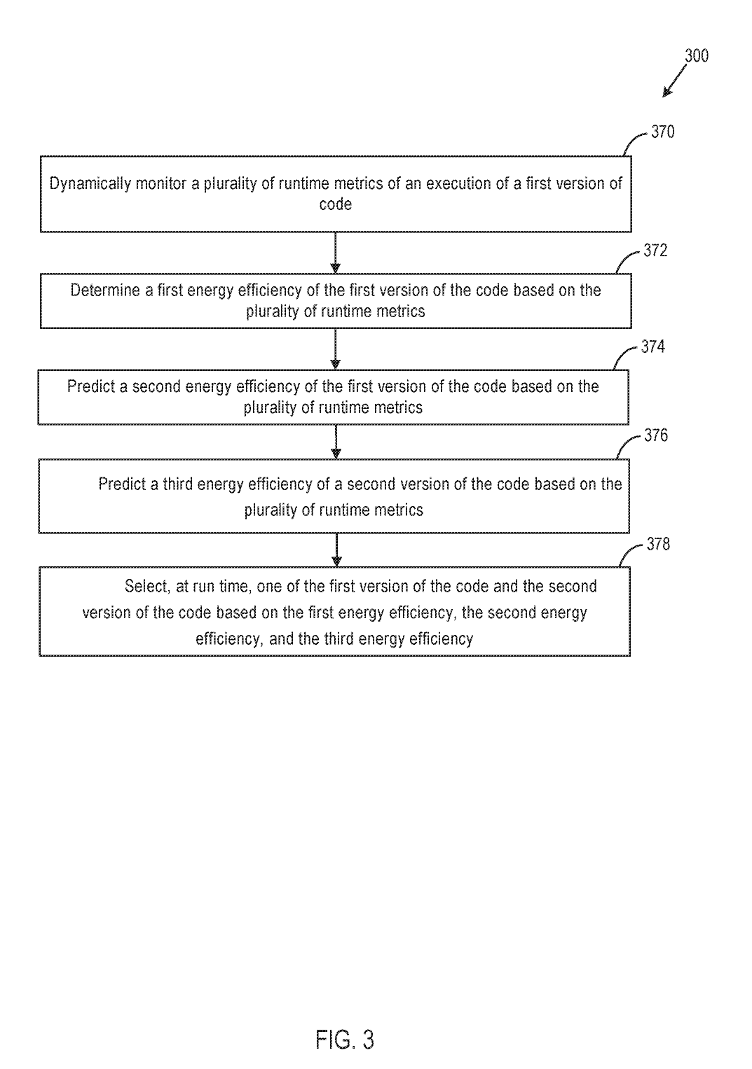

FIG. 3 is a flow diagram illustrating a method 300 for dynamically predicting and enhancing energy efficiency according to various embodiments. The method 300 comprises dynamically monitoring 370 a plurality of runtime metrics of an execution of a first version of code; determining 372 a first energy efficiency of the first version of the code based on the plurality of runtime metrics; predicting 374 a second energy efficiency of the first version of the code based on the plurality of runtime metrics; predicting 376 a third energy efficiency of a second version of the code based on the plurality of runtime metrics; and selecting 378, at run time, one of the first version of the code and the second version of the code based on the first energy efficiency, the second energy efficiency, and the third energy efficiency.

Dynamically monitoring 370 the plurality of runtime metrics can further comprise dynamically monitoring power metrics and performance metrics. The performance metrics can be determined based on the dynamic execution of the code. The metrics can be mapped to instruction pointers corresponding to the plurality of versions of the code.

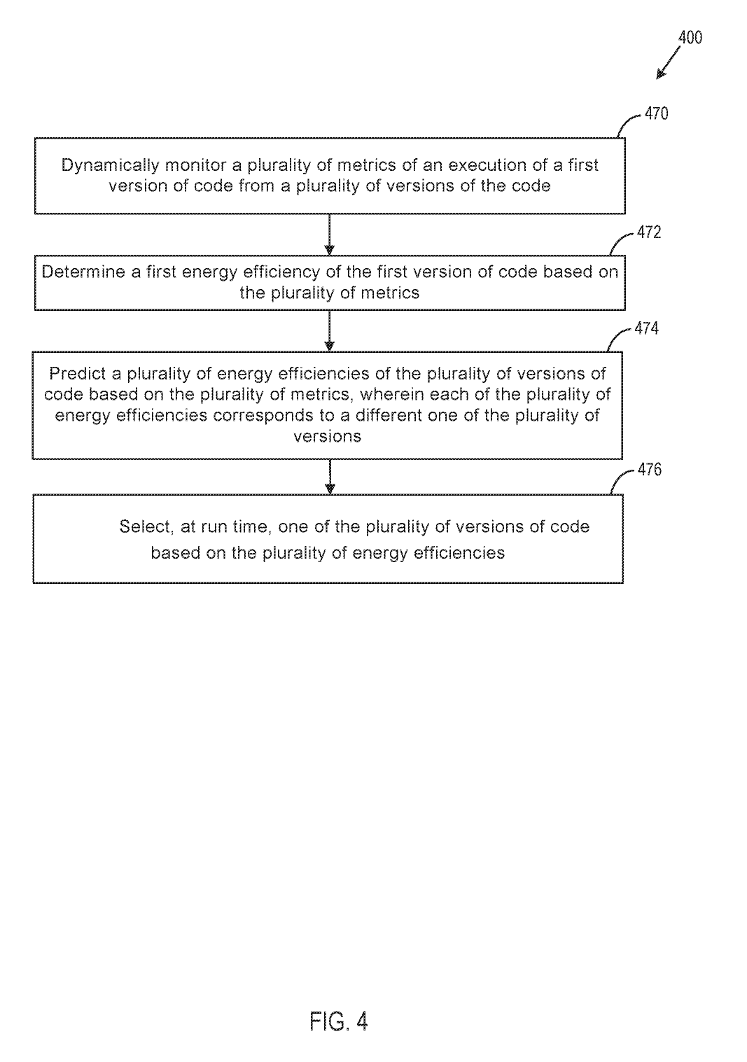

FIG. 4 is a flow diagram illustrating a method 400 for dynamically predicting and enhancing energy efficiency according to various embodiments. The method 400 can include dynamically monitoring 470 a plurality of metrics of an execution of a first version of code from a plurality of versions of the code; determining 472 a first energy efficiency of the first version of code based on the plurality of metrics; predicting 474 a plurality of energy efficiencies of the plurality of versions of code based on the plurality of metrics, wherein each of the plurality of energy efficiencies corresponds to a different one of the plurality of versions; and selecting 476, at run time, one of the plurality of versions of code based on the plurality of energy efficiencies.

The plurality of metrics can comprise one or more of power consumption metrics, temperature metrics, current metrics, and execution packed vector instructions metrics. The plurality of metrics can comprise one or more of instructions per cycle metrics, memory bandwidth usage metrics, and wait and sleep instruction metrics. The plurality of metrics can comprise one or more of IPC metrics and IPC weighted by code versions metrics.

The method 400 can also comprise generating the plurality of versions of the code based on source annotations of the code. Predicting the plurality of energy efficiencies of the plurality of versions of code can further comprise predicting the plurality of energy efficiencies of the plurality of versions of code based on a history of predictions. The history of predictions can be controlled by logic particular to the architecture of the computing device.

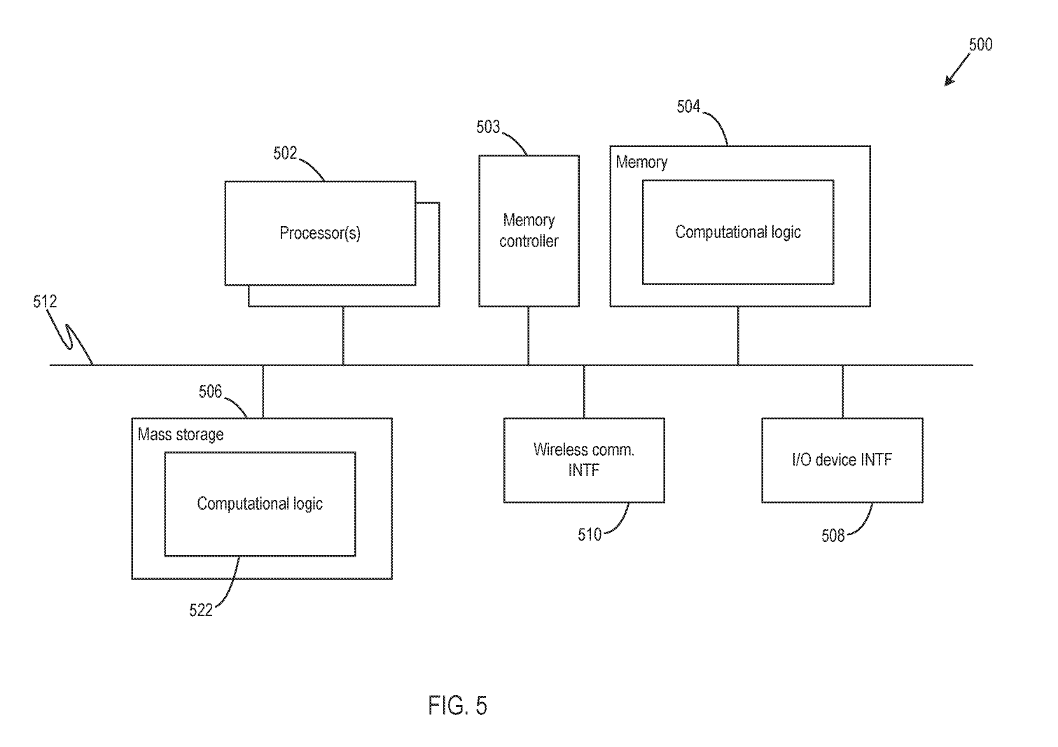

FIG. 5 illustrates an example of a computing device 500 suitable for use to practice aspects of the present disclosure, according to various embodiments. As shown, the computing device 500 may include one or more processors 502, each with one or more processor cores; system memory 504; and a memory controller 503. The system memory 504 may be any volatile or non-volatile memory. Additionally, the computing device 500 may include mass storage devices 506. Example of the mass storage devices 506 may include, but are not limited to, tape drives, hard drives, compact disc read-only memory (CD-ROM), and so forth. Further, the computing device 500 may include input/output devices 508 (such as display, keyboard, cursor control, and so forth) and communication interfaces 510 (such as wireless and/or wired communication/network interface cards, modems, and so forth). The elements may be coupled to each other via a system bus 512, which may represent one or more buses. In the case of multiple buses, they may be bridged by one or more bus bridges (not shown).

Each of these elements may perform its conventional functions known in the art. The system memory 504 and the mass storage devices 506 may be employed to store a working copy and a permanent copy of the programming instructions implementing a number of operations referred to as computational logic 522. The memory controller 503 may include internal memory to store a working copy and a permanent copy of the programming instructions implementing a number of operations associated with predicting and enhancing energy efficiency of applications. The computational logic 522 may be implemented by assembler instructions supported by the processor(s) 502 or high-level languages, such as, for example, C, that can be compiled into such instructions.

The number, capability, and/or capacity of these elements 510 and 512 may vary, depending on whether the computing device 500 is used as a mobile device, such as a wearable device, a smartphone, a computer tablet, a laptop, and so forth, or a stationary device, such as a desktop computer, a server, a game console, a set-top box, an infotainment console, and so forth. Otherwise, the constitutions of elements 510 and 512 are known, and accordingly will not be further described.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module,” or “system.” Furthermore, the present disclosure may take the form of a computer program product embodied in any tangible or non-transitory medium of expression having computer-usable program code embodied in the medium.

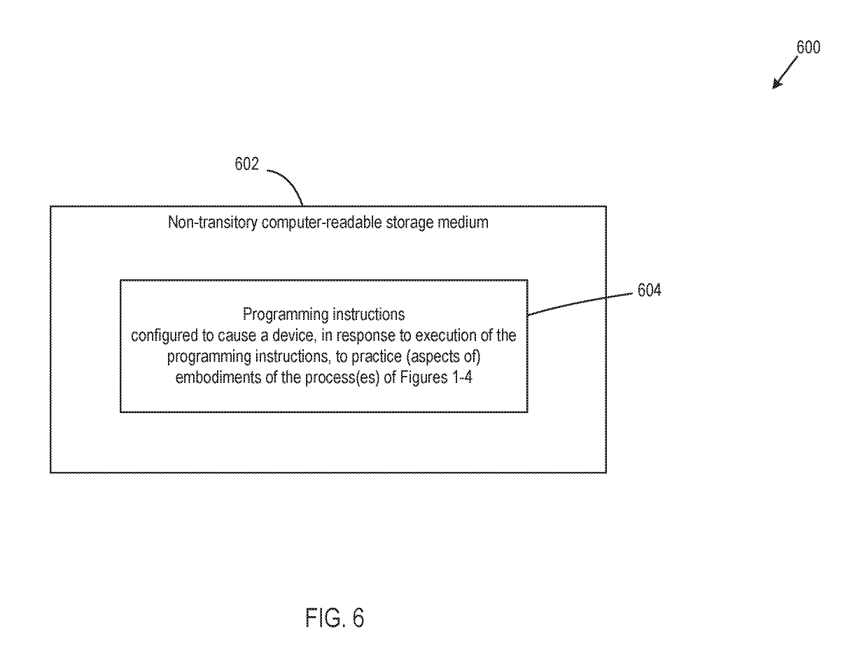

FIG. 6 illustrates an example non-transitory computer-readable storage medium that may be suitable for use to store instructions that cause an apparatus, in response to execution of the instructions by the apparatus, to practice selected aspects of the present disclosure. As shown, a non-transitory computer-readable storage medium 602 may include a number of programming instructions 604. The programming instructions 604 may be configured to enable a device (e.g., the computing device 500 in FIG. 5), in response to execution of the programming instructions 604, to implement (aspects of) the system 100 in FIG. 1, as earlier described. In alternative embodiments, the programming instructions 604 may be disposed on multiple non-transitory computer-readable storage media 602 instead. In still other embodiments, the programming instructions 604 may be disposed on the multiple non-transitory computer-readable storage media 602, such as, signals.

Any combination of one or more computer-usable or computer-readable medium(s) may be utilized. The computer-usable or computer-readable medium may be, for example, but is not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++, or the like and conventional procedural programming languages, such as the “C” programming language or similar programming languages. The program code may execute entirely on the user's computer; partly on the user's computer, as a stand-alone software package; partly on the user's computer and partly on a remote computer; or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an,” and “the” are intended to include plural forms as well, unless the context clearly indicates otherwise. It will be further understood that the terms “comprises” and/or “comprising,” when used in this specification, are specific to the presence of stated features, integers, steps, operations, elements, and/or components, but do not preclude the presence or addition of one or more other features, integers, steps, operation, elements, components, and/or groups thereof.

Embodiments may be implemented as a computer process, a computing system, or an article of manufacture such as a computer program product of computer-readable media. The computer program product may be a computer storage medium readable by a computer system and encoding computer program instructions for executing a computer process.

The corresponding structures, materials, acts, and equivalents of all means or steps plus function elements in the claims below are intended to include any structure, material, or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Referring back to FIG. 5, for one embodiment, at least one of the processors 502 may be packaged together with memory, as earlier described. For one embodiment, at least one of the processors 502 may be packaged together with memory to form a System in Package (SiP). For one embodiment, at least one of the processors 502 may be integrated on the same die with memory. For one embodiment, at least one of the processors 502 may be packaged together with memory to form a system on chip (SoC). For at least one embodiment, the SoC may be utilized in, (e.g., but not limited to, a wearable device, a smartphone or a computing tablet.)

Thus, various example embodiments of the present disclosure have been described, including, but not limited to:

Example 1 is an apparatus. The apparatus is a device to select a code path at run time, including electronic memory to store a variety of versions of code, a variety of metrics of the variety of versions of the code, and a variety of predictors of energy efficient performance corresponding to the variety of versions of the code. The apparatus is a device to select a code path at run time, including one or more processors designed to determine that the code path for the code executed at run time includes a branch. The apparatus is a device to select a code path at run time, including one or more processors designed to select a path, corresponding to one of the variety of versions of the code, from the branch based on the variety of predictors, the variety of metrics, and the variety of versions of the code, and provide the code associated with the path to a processing unit for execution.

Example 2 is the apparatus of Example 1, where the one or more processors are further designed to generate the variety of predictors based on the variety of metrics.

Example 3 is the apparatus of Example 1, where the variety of predictors are generated by an energy efficient predictor unit.

Example 4 is the apparatus of Example 1, where each of the variety of predictors includes a ratio of one or more performance metrics to one or more energy efficiency metrics.

Example 5 is the apparatus of Example 4, where lower predictors are selected over higher predictors.

Example 6 is the apparatus of Example 1, where the one or more processors are further designed to generate the variety of versions of the code at compile time.

Example 7 is the apparatus of Example 1, where the one or more processors are further designed to generate the variety of versions of the code at compile time as defined by a compiler.

Example 8 is the apparatus of Example 1, where the variety of versions of the code include a variety of versions of a block of the code.

Example 9 is the apparatus of Example 8, where the block of the code includes a loop of code that is part of the code.

Example 10 is the apparatus of Example 1, where of the variety of versions of the code include different versions for a same code.

Example 11 is the apparatus of Example 1, where the one or more processors are further designed to generate the metrics at run time.

Example 12 is the apparatus of Example 1, where the one or more processors are further designed to generate the metrics at compile time.

Example 13 is a computer-readable storage medium. The computer-readable storage medium having stored thereon instructions that, when implemented by a computing device, cause the computing device to dynamically monitor a variety of runtime metrics of an execution of a first version of code, and determine a first energy efficiency of the first version of the code based on the variety of runtime metrics. The computer-readable storage medium having stored thereon instructions that, when implemented by a computing device, cause the computing device to predict a second energy efficiency of the first version of the code based on the variety of runtime metrics, predict a third energy efficiency of a second version of the code based on the variety of runtime metrics, and select, at run time, one of the first version of the code and the second version of the code based on the first energy efficiency, the second energy efficiency, and the third energy efficiency.

Example 14 is the computer-readable storage medium of Example 13, where the instructions to dynamically monitor the variety of runtime metrics further includes instructions to dynamically monitor power metrics and performance metrics.

Example 15 is the computer-readable storage medium of Example 14, where the performance metrics are determined based on a dynamic execution of the code.

Example 16 is the computer-readable storage medium of Example 13, where the variety of runtime metrics are mapped to instruction pointers corresponding to the first version of the code and the second version of the code.

Example 17 is a method to select a code path at run time. The method includes dynamically monitoring a variety of metrics of an execution of a first version of code from a variety of versions of the code, and determining a first energy efficiency of the first version of the code based on the variety of metrics. The method includes predicting a variety of energy efficiencies of the variety of versions of the code based on the variety of metrics, where each of the variety of energy efficiencies corresponds to a different one of the variety of versions, and selecting, at run time, one of the variety of versions of the code based on the variety of energy efficiencies.

Example 18 is the method of Example 17, where the variety of metrics includes one or more of power consumption metrics, temperature metrics, current metrics, and execution packet vector instructions metrics.

Example 19 is the method of Example 17, where the variety of metrics includes one or more of instructions per cycle metrics, memory bandwidth usage metrics, and wait and sleep instruction metrics.

Example 20 is the method of Example 19, where the variety of metrics includes one or more of instructions per cycle (IPC) metrics and IPC weighted by code versions metrics.

Example 21 is the method of Example 17, further comprising generating the variety of versions of the code based on source annotations of the code.

Example 22 is the method of Example 17, where predicting the variety of energy efficiencies of the variety of versions of the code further includes predicting the variety of energy efficiencies of the variety of versions of the code based on a history of predictions.

Example 23 is the method of Example 22, where the history of predictions can be controlled by logic particular to an architecture of a computing device.

Example 24 is a method for selecting a code path at run time. The method includes determining that the code path for code executed at run time includes a branch, and selecting a path, corresponding to one of a variety of versions of the code, from the branch based on a variety of predictors of energy efficient performance corresponding to the variety of version of the code, a variety of metrics of the variety of versions of the code, and the variety of versions of the code. The method includes providing the code associated with the path to a processing unit for execution.

Example 25 is the method of Example 24, further comprising generating the variety of predictors based on the variety of metrics.

Example 26 is the method of Example 24, where the variety of predictors are generated by an energy efficient predictor unit.

Example 27 is the method of Example 24, where each of the variety of predictors includes a ratio of one or more performance metrics to one or more energy efficiency metrics.

Example 28 is the method of Example 27, where lower predictors are selected over higher predictors.

Example 29 is the method of Example 24, further comprising generating the variety of versions of the code at compile time.

Example 30 is the method of Example 24, further comprising generating the variety of versions of the code at compile time as defined by a compiler.

Example 31 is the method of Example 24, where the variety of versions of the code includes a variety of versions of a block of the code.

Example 32 is the method of Example 31, where the block of the code includes a loop of code that is part of the code.

Example 33 is the method of Example 24, where of the variety of versions of the code includes different versions for a same code.

Example 34 is the method of Example 24, further comprising generating the metrics at run time.

Example 35 is the method of Example 24, further comprising generating the metrics at compile time.

Example 36 is a method for selecting a code path at run time. The method includes dynamically monitoring a variety of runtime metrics of an execution of a first version of code, and determining a first energy efficiency of the first version of the code based on the variety of runtime metrics. The method includes predicting a second energy efficiency of the first version of the code based on the variety of runtime metrics, predicting a third energy efficiency of a second version of the code based on the variety of runtime metrics, and selecting, at run time, one of the first version of the code and the second version of the code based on the first energy efficiency, the second energy efficiency, and the third energy efficiency.

Example 37 is the method of Example 36, where dynamically monitoring the variety of runtime metrics further includes dynamically monitoring power metrics and performance metrics.

Example 38 is the method of Example 37, where the performance metrics are determined based on a dynamic execution of the code.

Example 39 is the method of Example 36, where the variety of runtime metrics are mapped to instruction pointers corresponding to the first version of the code and the second version of the code.

Example 40 is at least one computer-readable storage medium having stored thereon computer-readable instructions, when executed, to implement a method as exemplified in any of Examples 17-39.

Example 41 is an apparatus comprising a manner to perform a method as exemplified in any of Examples 17-39.

Example 42 is a means for performing a manner as exemplified in any of Examples 17-39.

As used herein, the term “module” may refer to, be part of, or include an application specific integrated circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

It will be obvious to those having skill in the art that many changes may be made to the details of the above-described embodiments without departing from the underlying principles of the invention. The scope of the present invention should, therefore, be determined only by the following claims.

It will be understood by those having skill in the art that many changes may be made to the details of the above-described embodiments without departing from the underlying principles of the invention. The scope of the present invention should, therefore, be determined only by the following claims.

1. An apparatus of a device to select a code path at run time, comprising:
electronic memory to store a plurality of versions of code, a plurality of metrics of the plurality of versions of the code, and a plurality of predictors of energy efficient performance corresponding to the plurality of versions of the code; and
one or more processors configured to:
determine that the code path for the code executed at run time comprises a branch;
select a path, corresponding to one of the plurality of versions of the code, from the branch based on the plurality of predictors, the plurality of metrics, and the plurality of versions of the code; and
provide the code associated with the path to a processing unit for execution.

2. The apparatus of claim 1, wherein the one or more processors are further configured to generate the plurality of predictors based on the plurality of metrics.

3. The apparatus of claim 1, wherein the plurality of predictors are generated by an energy efficient predictor unit.

4. The apparatus of claim 1, wherein each of the plurality of predictors includes a ratio of one or more performance metrics to one or more energy efficiency metrics.

5. The apparatus of claim 4, wherein lower predictors are selected over higher predictors.

6. The apparatus of claim 1, wherein the one or more processors are further configured to generate the plurality of versions of the code at compile time.

7. The apparatus of claim 1, wherein the one or more processors are further configured to generate the plurality of versions of the code at compile time as defined by a compiler.

8. The apparatus of claim 1, wherein the plurality of versions of the code comprise a plurality of versions of a block of the code.

9. The apparatus of claim 8, wherein the block of the code comprises a loop of code that is part of the code.

10. The apparatus of claim 1, wherein of the plurality of versions of the code comprise different versions for a same code.

11. The apparatus of claim 1, wherein the one or more processors are further configured to generate the metrics at run time.

12. The apparatus of claim 1, wherein the one or more processors are further configured to generate the metrics at compile time.

13. A computer-readable storage medium having stored thereon instructions that, when implemented by a computing device, cause the computing device to:
dynamically monitor a plurality of runtime metrics of an execution of a first version of code;
determine a first energy efficiency of the first version of the code based on the plurality of runtime metrics;
predict a second energy efficiency of the first version of the code based on the plurality of runtime metrics;
predict a third energy efficiency of a second version of the code based on the plurality of runtime metrics; and
select, at run time, one of the first version of the code and the second version of the code based on the first energy efficiency, the second energy efficiency, and the third energy efficiency.

14. The computer-readable storage medium of claim 13, wherein the instructions to dynamically monitor the plurality of runtime metrics further comprise instructions to dynamically monitor power metrics and performance metrics.

15. The computer-readable storage medium of claim 14, wherein the performance metrics are determined based on a dynamic execution of the code.

16. The computer-readable storage medium of claim 13, wherein the plurality of runtime metrics are mapped to instruction pointers corresponding to the first version of the code and the second version of the code.

17. A method to select a code path at run time, comprising:
dynamically monitoring a plurality of metrics of an execution of a first version of code from a plurality of versions of the code;
determining a first energy efficiency of the first version of the code based on the plurality of metrics;
predicting a plurality of energy efficiencies of the plurality of versions of the code based on the plurality of metrics, wherein each of the plurality of energy efficiencies corresponds to a different one of the plurality of versions; and
selecting, at run time, one of the plurality of versions of the code based on the plurality of energy efficiencies.

18. The method of claim 17, wherein the plurality of metrics comprise one or more of power consumption metrics, temperature metrics, current metrics, and execution packet vector instructions metrics.

19. The method of claim 17, wherein the plurality of metrics comprise one or more of instructions per cycle metrics, memory bandwidth usage metrics, and wait and sleep instruction metrics.

20. The method of claim 19, wherein the plurality of metrics comprise one or more of instructions per cycle (IPC) metrics and IPC weighted by code versions metrics.

21. The method of claim 17, further comprising generating the plurality of versions of the code based on source annotations of the code.

22. The method of claim 17, wherein predicting the plurality of energy efficiencies of the plurality of versions of the code further comprises predicting the plurality of energy efficiencies of the plurality of versions of the code based on a history of predictions.

23. The method of claim 22, wherein the history of predictions can be controlled by logic particular to an architecture of a computing device.
